(19) United States
(12) Patent Application Publication
(10) Pub. No.: US 2021/0099741 A1
(43) Pub. Date: Apr. 1, 2021

(54) METHOD AND APPARATUS FOR MAINTAINING BANDWIDTH FOR ELECTRONIC CONTENT DISPLAY SYSTEM

(71) Applicant: Rovi Guides, Inc., San Jose, CA (US)

(72) Inventors: Jeffrey Charles Hale, Los Altos, CA (US); Chul Ho Hyon, San Jose, CA (US); Gabriel C. Dalbec, Morgan Hill, CA (US)

(21) Appl. No.: 16/586,795

(22) Filed: Sep. 27, 2019

(51) Int. Cl. H04N 21/241; H04N 21/2385; H04N 21/262; H04N 21/24

(52) U.S. Cl. CPC H04N 21/241; H04N 21/2402; H04N 21/26216; H04N 21/2385

(57) ABSTRACT

Systems and methods for ensuring that sufficient network bandwidth exists to support proper operation of an IPTV service. An application monitoring device monitors one or more networked devices that collectively run an IPTV application and various other applications. The application monitoring device determines the amount of network bandwidth used by these various other applications. If the applications use sufficient bandwidth that an insufficient amount remains for proper operation of the IPTV application, the application monitoring device may reduce the amount of bandwidth used by the various applications. Bandwidth reduction may be accomplished by, for example, identifying certain applications that consume excessive bandwidth, and instructing the applications to close, throttle their bandwidth usage, or pause one or more operations.

### BACKGROUND

Embodiments of the disclosure relate generally to electronic content display systems. More specifically, embodiments of the disclosure relate to systems for maintaining bandwidth for an electronic content display system.

### SUMMARY

Contemporary electronic communications networks have led to significant improvements in the distribution and display of electronic content. One particular improvement involves the development of content display services such as internet protocol television (IPTV). Such IPTV services stream television or other content feeds to users through an electronic communications network such as a local area network connected to the public internet, allowing users to view television content on any internet-enabled display device, anywhere that they have network access.

Such IPTV systems have associated limitations, however. Current electronic communications networks often are not allocated sufficient bandwidth to simultaneously support both an IPTV feed and a number of other applications. Thus, other applications may consume bandwidth needed for the IPTV application, interrupting or otherwise compromising its display of content. No services currently exist for ensuring IPTV performance by maintaining or reserving network bandwidth for an IPTV service.

Accordingly, to overcome the problems and limitations of inadequate bandwidth allocation for electronic communications networks, systems and methods are described herein for a computer-based process that maintains sufficient bandwidth for an IPTV application by monitoring available allocated network bandwidth and limiting, or attempting to limit, bandwidth used by other applications on the same network if available bandwidth drops below what is required by the IPTV application. More specifically, embodiments of the disclosure can be employed within a network with a particular bandwidth allocation or capacity, and one or more devices that collectively run an IPTV application as well as other applications. These other applications are monitored to determine the bandwidth they currently use, which may determine the allocated bandwidth not used by the applications and thus available for the IPTV application. If the available network bandwidth is less than the bandwidth required by the IPTV application, or if the current bandwidth used by the IPTV application is too low, an instruction may be transmitted to reduce the bandwidth used by the other applications, so as to free up sufficient bandwidth for the IPTV application. More particularly, specific ones of these other applications may be identified, closure or throttling of which would result in sufficient bandwidth for the IPTV application. The instruction may thus be an instruction to throttle, close, or otherwise reduce the bandwidth ussed by these specific applicaitons.

Any action may be taken in order to reduce the bandwidth taken up by specified applications. In one embodiment, instructions may be issued to close particular applications. Applications may be selected for closure based on any criteria. For example, instructions may be issued to close the open or running application that has been least recently used. That is, the applications that have been open or running the longest without use may be the applications targeted for closure. As another example, the applications selected for closure may be those applications which consume the most bandwidth. As yet another example, the applications selected for closure may be the most recently opened or loaded applications. That is, newest applications may be closed first.

As above, applications may have their bandwidth consumption reduced in other ways besides closure. One or more applications may be paused or suspended rather than closed, for instance. Thus, issued instructions may be instructions to pause one or more operations of a particular application. For example, certain applications may at times consume large portions of network bandwidth by downloading large amounts of information. Users may therefore be asked if they wish to pause such downloads until, for instance, the current program streaming via the IPTV application is completed, or the IPTV application is closed.

Bandwidth-consuming applications may also be throttled, rather than closed. That is, identified applications may be kept open and running but may have their bandwidth usage reduced, such as by reducing their data transfer rate.

The above described instructions may be directives to take particular actions, or may be requests asking the user to take particular actions. Thus, the above instructions may be commands directing a user or device to close, throttle, or pause particular applications, or may be requests asking a user to close, throttle, or pause particular applications.

It is noted that application programs are not the only consumers of allocated bandwidth. Other processes and programs may also consume bandwidth, and these may also be paused, throttled, closed, or the like, to free up bandwidth for the IPTV application. As one example, operating system processes may occupy bandwidth and thus may be paused or throttled. Thus, various operating system processes which occupy bandwidth, such as downloads for system updates, may be identified and an instruction may be issued to throttle or pause these processes.

Embodiments of the disclosure also include systems for carrying out the above described actions and methods. An exemplary such system includes one or more devices that run the above IPTV and other applications, as well as a separate application monitoring device. The application monitoring device performs many of the above described operations. In particular, it monitors the applications running on the various other devices to determine the amount of available network bandwidth, and compares this to a predetermined amount of bandwidth deemed to be desired for the IPTV application. If the available bandwidth is less than this predetermined amount, the application monitoring device transmits an instruction to reduce the bandwidth used by various other applications, by an amount at least sufficient to increase the available bandwidth beyond the predetermined amount. That is, the application monitoring device issues instructions to the other devices of this system, to maintain their bandwidth usage at a level that allows the IPTV application to continue operating properly. The instructions issued by the application monitoring device may be as described above.

### BRIEF DESCRIPTION OF THE FIGURES

The above and other objects and advantages of the disclosure will be apparent upon consideration of the following detailed description, taken in conjunction with the accompanying drawings, in which like reference characters refer to like parts throughout, and in which:

FIG. 1 illustrates an exemplary system for maintaining network bandwidth for an electronic content display application, performed in accordance with embodiments of the disclosure;

FIG. 2 is a block diagram illustration of a system for implementing the process of FIG. 1;

FIG. 3 is a generalized embodiment of illustrative network-connected devices constructed for use according to embodiments of the disclosure;

FIG. 4 is a generalized embodiment of an illustrative application monitoring device constructed for use according to embodiments of the disclosure;

FIG. 5 is a generalized embodiment of an illustrative IPTV device constructed for use according to embodiments of the disclosure;

FIG. 6 is a flowchart illustrating process steps for maintaining network bandwidth for an electronic content display application, in accordance with embodiments of the disclosure.

### DETAILED DESCRIPTION

In one embodiment, the disclosure relates to systems and methods for ensuring that sufficient network bandwidth exists to support proper operation of an IPTV service. An application monitoring device monitors one or more networked devices that collectively run an IPTV application and various other applications. The application monitoring device determines the amount of allocated network bandwidth used by these various other applications. If the applications use sufficient bandwidth that an insufficient amount remains for proper operation of the IPTV application, the application monitoring device reduces the amount of bandwidth used by the various other applications. Bandwidth reduction is accomplished by identifying certain applications that consume excessive bandwidth, and instructing the applications to close, throttle their bandwidth usage, or pause one or more operations.

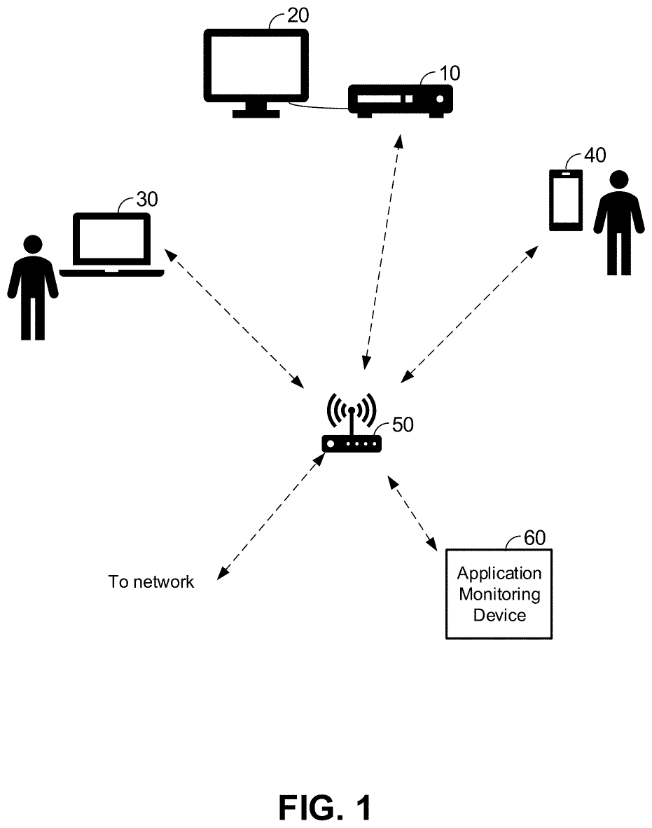

FIG. 1 illustrates an exemplary system for maintaining bandwidth available to an electronic content display application, performed in accordance with embodiments of the disclosure. Here, a number of devices including a set-top box 10, a laptop computer 30, and a cellular telephone 40 are in electronic communication with a router 50. Router 50 is in turn communicating with an electronic communications network, and an application monitoring device 60. The set-top box 10 may implement an electronic program guide and/or an IPTV application, and retrieve electronic content from remote services via the electronic communications network 210 and router 50, displaying this electronic content on display 20 for viewing by users. Devices 10, 30, and 40, router 50, and application monitoring device 60 may collectively comprise a local area network (LAN) or other network that allows communication between these various devices.

In operation, a network service provider such as an Internet service provider (ISP) allocates a specified amount of bandwidth for use by the above described LAN. Within this LAN, set-top box 10 may run an IPTV application that allows users to select various electronic content to be played on display 20. This electronic content is streamed from a remote content provider (not shown) through an electronic communications network such as the public Internet, to router 50 where it is directed to set-top box 10 for display on display 20. Simultaneously, users of laptop 30 and phone 40 may run other applications on their respective devices. These applications, as well as the IPTV application run on set-top box 10, each consume bandwidth allocated to the LAN.

The application monitoring device 60 requests information from router 50 including the amount of allocated bandwidth consumed by each application of each device 10, 30, 40 to which it is connected, as well as the bandwidth available. Further details of how device 60 requests and/or is provided this information are given below. If the bandwidth information supplied by router 50 indicates that insufficient allocated bandwidth remains for the IPTV application of set-top box 10, the IPTV application may not be able to stream content reliably, or at a sufficient image quality level for users to enjoy. Accordingly, the application monitoring device 60 attempts to free sufficient bandwidth for the IPTV application to properly display content to users. To that end, the application monitoring device 60 identifies one or more applications that collectively use an amount of bandwidth at least equal to an amount which, if freed for use, would allow the IPTV application to run properly. The application monitoring device 60 transmits an instruction to the devices running these identified applications, to take a specified action to reduce the bandwidth used by those applications. Further details of how device 60 may accomplish bandwidth use reduction are given below.

The instruction may be an instruction requesting the users of those devices to close the identified applications, or may be a request to reduce the bandwidth used by these applications in another manner, such as a request to stop or pause certain bandwidth-consuming operations of the applications. For example, the instruction may be a request to pause an application's download of data, pause play of a game application, or the like. The instruction may also be a directive rather than a request, such as an instruction to the user to close certain applications, and/or an instruction directly and automatically closing the identified application without any user action required. The application monitoring device 60 may select or identify applications in any manner, as further described below.

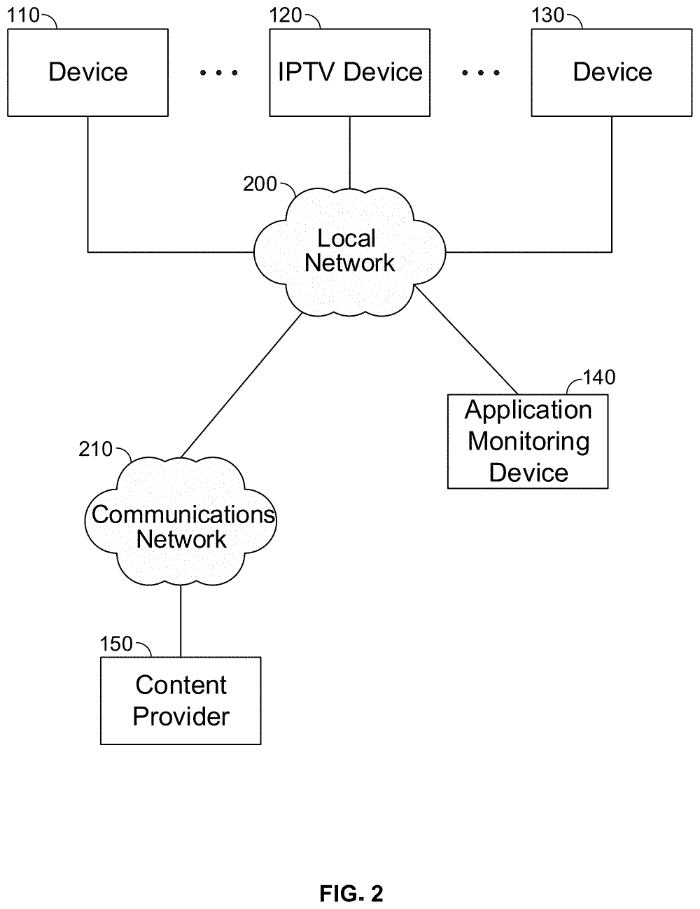

FIG. 2 is a block diagram representation of a system for implementing the networked environment of FIG. 1, presented for further illustration. Any number of content consumption devices 110, 120, 130 may be in communication with application monitoring device 140 through, for example, a local network 200. Here, content consumption devices 110 and 130 may correspond to devices 30 and 40, while content consumption device 120 may be an IPTV device corresponding to device 10. Any number of content consumption devices 110, 130 and corresponding devices 30, 40 is contemplated. Local network 200 may include router 50.

The application monitoring device 140, which corresponds to application monitoring device 60, is shown as being in electronic communication with devices 110-130 through local network 200, e.g., through a router such as router 50. Alternatively, application monitoring device 140 may be a stand-alone device that is in communication with devices 110-130 via direct wired or wireless connection or via a different network such as communications network 210.

As one example, the content consumption devices 110-130, local network 200 (e.g., router 50), and application monitoring device 140 may all be situated within a local area, e.g., within the same vehicle, or within various rooms of a home or office, and may together comprise a LAN. The content provider 150 may be a remotely located server at a content provider site, and the communications network 210 may be the public Internet. Alternatively, the content provider 150 may be situated within the local area and may be, for example, a local content storage and streaming application on a local computer including any of the above computing devices, or even a storage and display application within the application monitoring device 140 itself. Multiple content providers 150 may be in communication with any device 110-140 through communications network 210 and/or local network 200. Content devices 10, 30, 40 may be examples of content consumption devices 120, 110, 130 respectively, and application monitoring device 60 may be an example of application monitoring device 140. As with set-top box 10 of FIG. 1, IPTV device 120 may be connected to a display such as display 20. This display may be a stand-alone device or may be another device 110, 130.

An ISP or other service provider may allocate a specified amount of bandwidth to local network 200 for use in communication between the local network 200 and communications network 210. Devices 110-130 use portions of this allocated bandwidth when they cause local network 200 to transfer information to communications network 210. For example, a user may be watching a show or playing other content on a display 20 via an IPTV service run on IPTV device 120, at which point the content provider 150 is providing a stream of the show or other content through communications network 210 and local network 200 to IPTV device 120. At the same time, various applications may be run on any other devices 110, 130. Both the IPTV service run on IPTV device 120, and any applications run on other devices 110, 130 consume portions of the bandwidth allocated to local network 200. The application monitoring device 140 monitors the bandwidth consumed by each application, and/or the remaining bandwidth of that amount allocated to network 200. Application monitoring device 140 also stores a predetermined bandwidth reservation value for the IPTV service run on IPTV device 120. This reservation value is an estimated minimum amount of allocated bandwidth that should be reserved for use by the IPTV service, to ensure that it runs as intended.

The application monitoring device 140 attempts to keep at least this predetermined amount of bandwidth free for exclusive use by the IPTV service of IPTV device 120. To accomplish this, the application monitoring device 140 communicates with one or more routers of local network 200 to determine the amount of bandwidth consumed by each application currently exchanging data across that network 200. The application monitoring device 140 then selects certain applications on the basis of their bandwidth usage, and transmits an instruction to each respective device 110-130 running one or more of the selected applications. As above, the instructions may be commands or requests, to close, throttle, or pause operations of the selected applications. In this manner, bandwidth may be freed for use by the IPTV service of device 120.

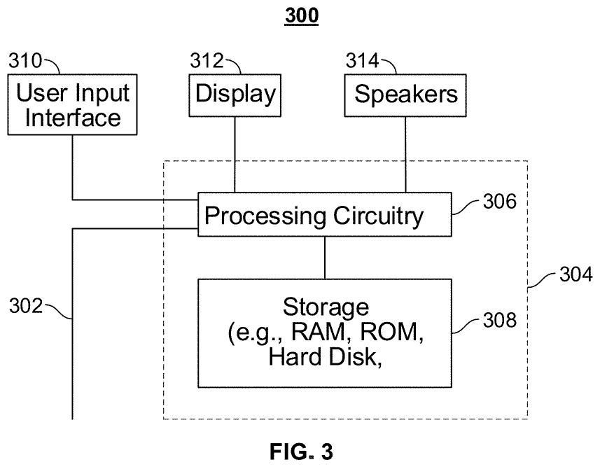

The devices 110 and 130, e.g., devices 30 and 40, may be any devices capable of running application programs, receiving streamed content and displaying the content for users. For example, devices 110, 130 may be digital TVs, laptop computers, smartphones, tablet computers, or the like. FIG. 3 shows a generalized embodiment of an illustrative device 300. Device 300 may receive content and data via input/output (hereinafter “I/O”) path 302. I/O path 302 may provide content (e.g., broadcast programming, on-demand programming, Internet content, content available over a LAN or a wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for receiving streamed content and executing its display, such as executing application programs that provide interfaces for content providers 150 to stream and display content.

Control circuitry 304 may thus include communications circuitry suitable for communicating with a content provider 150 server or other networks or servers. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be included. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

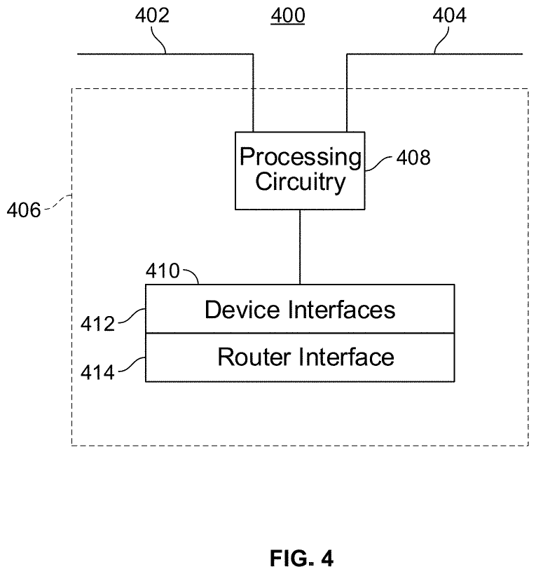

FIG. 4 is a generalized embodiment of an illustrative application monitoring device 140 constructed for use according to embodiments of the disclosure. Here, device 400 may serve as an application monitoring device 140. Device 400 may receive content and data via I/O paths 402 and 404. I/O path 402 may provide content and data to the various content consumption devices 110 and 130, while I/O path 404 may provide data to, and receive content from, one or more content providers 150. Like the user equipment device 300, the device 400 has control circuitry 406 which includes processing circuitry 408 and storage 410. The control circuitry 406, processing circuitry 408, and storage 410 may be constructed, and may operate, in similar manner to the respective components of user equipment device 300.

Storage 410 is a memory that stores a number of programs for execution by processing circuitry 408. In particular, storage 410 may store a number of device interfaces 412, and a router interface 414. The device interfaces 412 are interface programs for handling the exchange of commands and data with the various content consumption devices 110, 130. The router interface 414 is an interface program for handling the exchange of commands and data with routers of local network 200. A separate interface 414 may exist for each different router that has its own format for commands or content.

The device 400 may be any electronic device capable of communication with devices of network 200. For example, the device 400 may be a networked in-home smart device or personal assistant device connected between a home modem and various content consumption devices 110, 130. The device 400 may alternatively be a laptop computer or desktop computer configured as above. Device 400 may be a stand-alone device, or its functionality may be incorporated into any other device, such as router 50 or any of the other devices 110, 130.

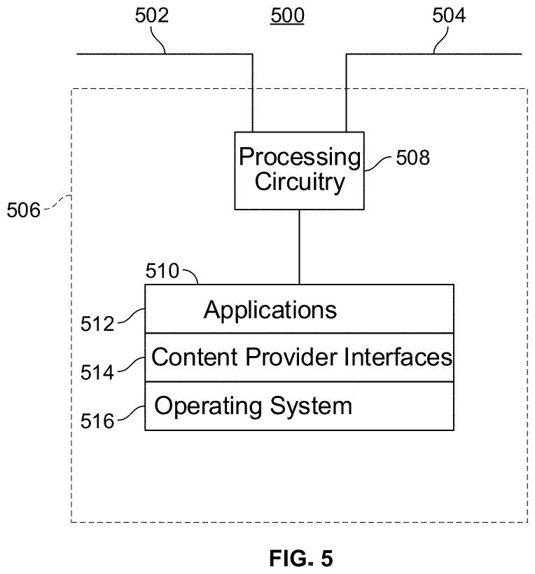

FIG. 5 is a generalized embodiment of an illustrative IPTV device 120 constructed for use according to embodiments of the disclosure. Here, device 500 may serve as a set-top box providing IPTV services. Device 500 may receive content and data via I/O paths 502 and 504. I/O path 502 may provide content and data to devices such as display 20, while I/O path 504 may provide data to, and receive content from, one or more content providers 150. Like the user equipment device 300, the device 500 includes processing circuitry 508 and storage 510. The processing circuitry 508 and storage 510 may be constructed, and may operate, in similar manner to the respective components of user equipment device 300.

Storage 510 stores various data and programs for execution or use by processing circuitry 508, including application programs 512, content provider interfaces 514, and operating system 516. The application programs 512 are any applications that can be run by a user, and can include an IPTV application for selection and streaming of content to display 20, an electronic program guide, and any other applications uses may wish to run. Such application programs 512 can include other content display applications such as Netflix®, YouTube®, or Amazon® applications, game or other entertainment applications, and the like. Content provider interfaces 514 are interface programs for handling the exchange of commands and content streams with various content providers 150. Operating system program 516 can be any operating system program that supports the basic functions of device 500 for executing application programs 512 and content provider interfaces 514 and providing basic services and information these programs use when running.

Application monitoring device 140 may monitor bandwidth in any manner. In one embodiment, application monitoring device 140 may communicate with each device 110, 130 via a protocol implemented for determination and communication of bandwidth used per application. More specifically, devices 110, 130 may implement a protocol for monitoring the bandwidth consumed by each of its currently running applications. Such a protocol may be implemented in device interfaces 412 and in a corresponding interface of memory 308, providing for example bandwidth monitoring capability and functions for communicating bandwidth monitoring data. These functions may be implemented in any manner, such as by polling monitoring functions of operating systems to determine bandwidth usage of applications currently being run, or in any other manner. The protocol may further support commands for closing, pausing, or throttling applications, in order to free up bandwidth for an IPTV application.

If certain devices 110, 130 do not support this protocol, application monitoring device 140 may default to any other method of determining bandwidth consumption and maintaining bandwidth for IPTV applications. For example, application monitoring device may default to device level or port level monitoring and throttling, as further described below.

In another embodiment, application monitoring device 140 may determine bandwidth consumption at the device level rather than the application level. That is, application monitoring device 140 may monitor the bandwidth consumption of each device 110, 130 rather than monitoring individual applications. Monitoring of device 110, 130 bandwidth may be performed in any manner, such as by querying router 50 for the bandwidth consumed by each of its devices 110, 130. Application monitoring device 140 may then free up bandwidth as desired by, for instance, instructing router 50 to throttle specific devices 110, 130.

In a further embodiment, application monitoring device 140 may determine bandwidth consumption at the port level. That is, application monitoring device 140 may monitor the bandwidth consumption of specific ports of router 50, such as by querying router 50 appropriately. Device 140 may then free up bandwidth as desired by, for example, instructing router 50 to throttle specific ports. This approach may be desirable as a proxy for monitoring and throttling specific applications, for example when it is known that certain applications use specific ports for their data transfer.

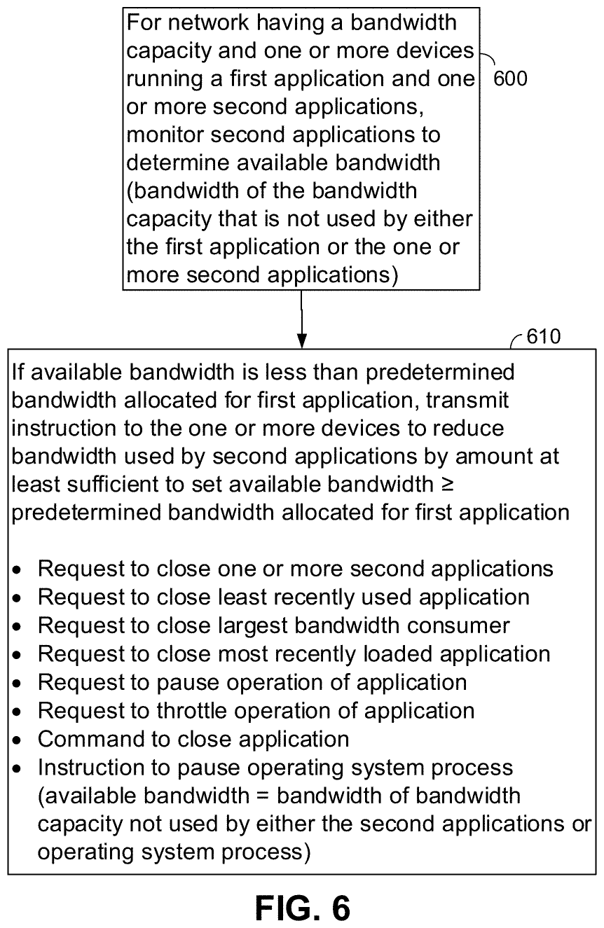

FIG. 6 is a flowchart illustrating process steps for maintaining bandwidth for an electronic content display application, in accordance with embodiments of the disclosure. Initially, a network 200 has a bandwidth amount or capacity allocated to it by an ISP. This bandwidth is at least partially consumed by an IPTV device 120 running an IPTV application and one or more devices 110, 130 running one or more other applications. Application monitoring device 140 monitors the applications run by the devices 110, 130 to determine how much of the bandwidth allocated to network 200 remains available (Step 600). The available bandwidth allocated to network 200 which is available for use by applications, one measure of which may be that bandwidth not being used by either the IPTV application or the various applications run on devices 110, 130. In another embodiment, a measure of available bandwidth may be that bandwidth allocated to network 200 which is not used by any application of any device of the network, or any other process of any device of network 200 such as an operating system process.

As above, application monitoring device 140 may store a predetermined bandwidth value corresponding to the amount of bandwidth required by an IPTV application of device 120 for consistent operation. If the available bandwidth is less than this predetermined bandwidth value, the network monitoring device 140 issues an instruction to the one or more devices 110, 130 to reduce the bandwidth used by one or more of the applications they are running. This instruction is an instruction to reduce the bandwidth used by these applications, by an amount at least sufficient to set the available bandwidth to be greater than or equal to the predetermined bandwidth value (Step 620).

In another embodiment, the application monitoring device 140 can select applications according to bandwidth used by the IPTV application, rather than available network bandwidth. Here, application monitoring device 140 can monitor the IPTV application and, if its bandwidth used drops below the predetermined bandwidth value, device 140 can select other applications for closing/pausing/throttling as described herein. For example, if the predetermined bandwidth value is 4.0 Mbps and the application monitoring device determines that the IPTV application is consuming significantly less than 4.0 Mbps of bandwidth, the device 140 may deem that the IPTV application does not have enough available network bandwidth to operate as intended. Device 140 may then select other applications as described herein for closing/pausing/throttling, in an attempt to raise the bandwidth used by the IPTV application to at least 4.0 Mbps.

The predetermined bandwidth value can be any value, determined in any manner. As one example, the bandwidth value can be a predetermined value corresponding to an estimate of the amount of bandwidth an IPTV application typically requires, e.g., 4.0 Mbps, and which should thus be reserved for its use. Available bandwidth may also be determined in any manner. For example, the application monitoring device 140 can determine the value by querying the network 200, e.g., router 50, for available bandwidth. As a further example, in embodiments in which functions of the application monitoring device 140 are built into various components of network 200 such as by programming of router 50, router 50 can monitor network traffic directly to determine available bandwidth, or to determine the bandwidth allocated to network 200 and the bandwidth utilized by the various applications of devices 110-130, where the available bandwidth is the difference between the allocated bandwidth amount and bandwidth utilized. The amount of bandwidth allocated to network 200 may also be a predetermined value stored in, e.g., storage 410 of an application monitoring device 400.

The instructions issued may be any instruction for reducing bandwidth. In one embodiment, the instructions may be instructions to close one or more particular applications. In another embodiment, the instructions may be instructions to pause operation of one or more applications, such as by invoking a pause function in a game application or a content playback application. In a further embodiment, the instructions may be instructions to throttle an operation of one or more applications such as by, e.g., reducing data transfer speed of an application by a specified amount. As one example, a content playback application may be throttled by capping its download speed, or reducing it by a specified amount.

The issued instructions may also be instructions for other programs besides application programs. As one example, application monitoring device 140 may issue instructions to reduce bandwidth taken up by operating system processes. In particular, certain operating system processes take up network bandwidth, such as system update processes that download updates from remote servers. The application monitoring device 140 may also monitor the amount of bandwidth taken up by such operating system processes and issue instructions to interrupt, pause, or throttle these processes.

The issued instructions may be commands or requests. That is, the application monitoring device may issue instructions to devices 110-130 either requesting that these devices 110-130 reduce the bandwidth used by certain of their applications, or instructing the devices 110-130 to take specified actions. In the former case, devices 110-130 or their users have the option of refusing to take the specified actions, e.g., declining an option to close a particular application, in which case an insufficient bandwidth condition for IPTV application of device 120 may persist. In the latter case, devices 110-130 automatically take the specified actions, e.g., closing, pausing, or throttling specific applications.

The application monitoring device 140 may identify specific applications in any manner. As one example, applications may be identified according to the network bandwidth they occupy, so that the selected applications free up an amount of bandwidth sufficient to increase the free or available bandwidth allocated to network 200 to an amount equal to or greater than the above described predetermined bandwidth value. That is, application monitoring device 140 identifies applications such that closure/pausing/throttling of these applications results in sufficient free bandwidth to allow the IPTV application of device 120 to operate without any significant compromise to its performance.

Applications may be selected in any manner. Embodiments of the disclosure contemplate any methods of selecting applications such that reducing their bandwidth usage results in sufficient available bandwidth for an IPTV application. In one embodiment, application monitoring device 140 may select least recently used applications, or applications that have remained open but unused the longest, as the applications that should be closed, paused, or throttled. In another embodiment, application monitoring device 140 may select those applications that consume the most bandwidth, e.g., applications may be selected in order of their bandwidth consumption, with highest bandwidth consumers selected first. In another embodiment, application monitoring device 140 may select those applications which have been most recently loaded. That is, applications may be selected in order of how recently they were loaded, with the newest or most recently loaded application selected first. In a further embodiment, application monitoring device 140 may select applications for throttling, accounting for the amount by which applications are to be throttled. For instance, applications may be throttled down to a specified bandwidth, e.g., 1.0 Mbps, and application monitoring device 140 may select applications while accounting for the fact that these applications will have their bandwidth consumption reduced to 1.0 Mbps rather than 0.0 Mbps. Selection of applications for throttling may be performed in any manner, such as according to any of the above methods.

In an exemplary embodiment, application monitoring device 140 may store a predetermined bandwidth value of 4.0 Mbps, i.e., it may be determined that the IPTV application of device 120 requires at least approximately 4.0 Mbps of that bandwidth allocated to network 200 in order to reliably function as intended. Application monitoring device 140 may then monitor network 200 to determine that devices 100, 130 are currently collectively running five different applications excluding the IPTV application, that take up 5.6, 12.3, 8.4, 2.2, and 3.6 Mbps, respectively. The application monitoring device 140 may also query router 50 to determine that the current bandwidth capacity or limit of network 200 is 35.0 Mbps. Application monitoring device 140 calculates the total bandwidth taken up by these applications to be 32.1 Mbps (5.6+12.3+8.4+2.2+3.6), which means that the network bandwidth available for the IPTV application is 35.0−32.1=2.9 Mbps. As 2.9<4.0 Mbps, application monitoring device 140 attempts to reduce the bandwidth taken up by the applications so as to free up at least 4.0 Mbps capacity for the IPTV application.

Application monitoring device 140 may then select applications according to any of the above methods. As one example, device 140 may select the largest bandwidth consumers first. In that case, device 140 would select the application consuming 12.3 Mbps, and would transmit an instruction to its device 110, 130 to reduce that application's bandwidth (e.g., by stopping the application, pausing it, throttling it, or the like). As stopping this application would result in 2.9+12.3=15.2 Mbps>4.0 Mbps of available bandwidth for the IPTV application, the application monitoring device 140 does not select any further applications for transmission of bandwidth reduction instructions.

As another example, application monitoring device 140 may select the least recently used applications (e.g., unused the longest) first. Thus, if the most recently used application is the application using 2.2 Mbps of bandwidth, the device 140 would select that application first. As 2.9+2.2 Mbps>4.0 Mbps, no further applications are selected. If selection of this application instead resulted in less than 4.0 Mbps of available bandwidth for the IPTV application, the device 140 would also select the next least recently used application for closure, continuing to select applications in order of most recent use until the sum of bandwidths of selected applications results in ≥4.0 Mbps of available network bandwidth.

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, applications may be selected in any manner, such as by least recently used, largest bandwidth consumption, most recently loaded, or by any other method. Selected applications may be commanded or requested to be closed, paused, throttled, or instructed to take any other bandwidth-reducing actions. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

1. A system for maintaining performance of an application, the system comprising:
an electronic communications network having a bandwidth capacity and including:
one or more devices running a first application and one or more second applications; and
an application monitoring device configured to:
monitor the one or more second applications to determine an available bandwidth of the bandwidth capacity, the available bandwidth being a bandwidth of the bandwidth capacity that is not used by the one or more second applications; and
if the available bandwidth is less than a predetermined bandwidth of the first application, transmit an instruction to the one or more devices, the instruction being an instruction to reduce a bandwidth used by the one or more second applications by an amount at least sufficient to set the available bandwidth to be greater than or equal to the predetermined bandwidth.

2. The system of claim 1, wherein the first application is an internet protocol television application.

3. The system of claim 1, wherein the instruction comprises a request to close at least one of the one or more second applications.

4. The system of claim 3, wherein the instruction comprises a request to close a least recently used application of the one or more second applications.

5. The system of claim 3, wherein the instruction comprises a request to close a largest bandwidth consumer of the one or more second applications.

6. The system of claim 3, wherein the instruction comprises a request to close a most recently loaded application of the one or more second applications.

7. The system of claim 1, wherein the instruction comprises a request to pause an operation of one of the one or more second applications.

8. The system of claim 1, wherein the instruction comprises a request to throttle an operation of one of the one or more second applications.

9. The system of claim 1, wherein the instruction comprises a command to close at least one of the one or more second applications.

10. The system of claim 1, wherein:
the available bandwidth is a bandwidth of the bandwidth capacity that is not used by either the one or more second applications or an operating system process; and
the transmitting further comprises, if the available bandwidth is less than the predetermined bandwidth, transmitting an instruction to pause the operating system process.

11. A method of maintaining performance of an application, the system comprising:
for an electronic communications network having a bandwidth capacity and including one or more devices running a first application and one or more second applications, monitoring the one or more second applications to determine an available bandwidth of the bandwidth capacity, the available bandwidth being a bandwidth of the bandwidth capacity that is not used by the one or more second applications; and
if the available bandwidth is less than a predetermined bandwidth of the first application, transmitting an instruction to the one or more devices, the instruction being an instruction to reduce a bandwidth used by the one or more second applications by an amount at least sufficient to set the available bandwidth to be greater than or equal to the predetermined bandwidth.

12. The method of claim 11, wherein the first application is an internet protocol television application.

13. The method of claim 11, wherein the instruction comprises a request to close at least one of the one or more second applications.

14. The method of claim 13, wherein the instruction comprises a request to close a least recently used application of the one or more second applications.

15. The method of claim 13, wherein the instruction comprises a request to close a largest bandwidth consumer of the one or more second applications.

16. The method of claim 13, wherein the instruction comprises a request to close a most recently loaded application of the one or more second applications.

17. The method of claim 11, wherein the instruction comprises a request to pause an operation of one of the one or more second applications.

18. The method of claim 11, wherein the instruction comprises a request to throttle an operation of one of the one or more second applications.

19. The method of claim 11, wherein the instruction comprises a command to close at least one of the one or more second applications.

20. The method of claim 11, wherein:
the available bandwidth is a bandwidth of the bandwidth capacity that is not used by either the one or more second applications or an operating system process; and
the transmitting further comprises, if the available bandwidth is less than the predetermined bandwidth, transmitting an instruction to pause the operating system process.

21-30. (canceled)
